(19) United States
(12) Patent Application Publication
(10) Pub. No.: US 2025/0371093 A1
(43) Pub. Date: Dec. 4, 2025

(54) INITIAL RESPONSE CACHE

(71) Applicant: Snowflake Inc., Bozeman, MT (US)

(72) Inventors: Samuel Haar, Northampton, MA (US); William A. Pugh, Seattle, WA (US); Abhinav Saini, Queens, NY (US)

(21) Appl. No.: 18/680,602

(22) Filed: May 31, 2024

(51) Int. Cl. G06F 16/957; G06F 9/451; G06F 16/953; G06F 21/53

(52) U.S. Cl. CPC G06F 16/9574; G06F 9/451; G06F 16/953; G06F 21/53; G06F 2221/033

(57) ABSTRACT

A data platform is provided. The data platform is configured to receive a request from a client device of a user to run a web application within a computing environment. It initiates an execution of the web application and determines the availability of a cached user interface state of the web application. Upon determining that the cached user interface state is available, the data platform fetches the cached user interface state from the datastore and communicates it to the client device. This allows for displaying an initial user interface to a user by the client device using the cached user interface state while continuing to initialize the web application as the initial user interface is displayed.

### TECHNICAL FIELD

Examples of the disclosure relate generally to databases and, more specifically, to accessing data in a database over a network.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems.

Providers of the data on a data platform may want to make the data available on the data platform to consumers of the data through a secure channel on a public network. Therefore, it would be desirable to access a database in a manner that provides high functionality in a secure manner.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform in communication with a cloud storage provider system, according to some examples.

FIG. 2 is a block diagram illustrating components of a compute service manager, according to some examples.

FIG. 3 is a block diagram illustrating components of an execution platform, according to some examples.

FIG. 4 is a deployment diagram of a computing environment for providing an application as a first-class database object, according to some examples.

FIG. 5A illustrates an initial response cache method, according to some examples.

FIG. 5B illustrates a sequence diagram of an initial response cache method, according to some examples.

FIG. 6 illustrates a diagrammatic representation of a machine in the form of a computer system within which a set of instructions can be executed for causing the machine to perform any one or more of the methodologies discussed herein, according to some examples.

### DETAILED DESCRIPTION

In the realm of data-driven applications operating within cloud-based platforms, having a responsive web application is desirable. Traditional web applications have benefited from various caching mechanisms to speed up load times and enhance user experience by storing frequently accessed data. However, dynamic server-driven applications face challenges due to their interactive and data-intensive nature.

Web applications, known for enabling rapid development of data applications by allowing developers to create and deploy interactive applications quickly, often suffer from slow startup times. This can be because of the need to fetch large volumes of data, set up execution environments, and render complex UI elements, which can lead to significant delays in application responsiveness.

Prior solutions, such as those employed by business intelligence tools, have attempted to mitigate these issues by caching query results on the backend. While this approach does reduce some load times, it fails to address the full spectrum of latency issues, particularly those related to the initial loading of the application and the management of user-specific data under varying permission levels.

As described in the present disclosure, an initial response cache specifically designed for web applications within the computing environment is provided. This approach not only caches the results of data queries but also the entire user interface state of the application as it was during its last use. This method allows for the timely rendering of the user interface of the web application upon subsequent accesses, improving the perceived performance by the end-user.

Moreover, the initial response cache approach provides flexibility in caching strategies, allowing developers to choose between user-specific caching and more generalized caching methods, thus supporting efficient data handling and security compliance. This dual-layer caching mechanism not only speeds up the application's responsiveness but also reduces the load on backend resources, leading to cost efficiencies.

In some examples, a request to run a web application within a computing environment is received from a client device of a user. Execution of the web application is initiated, and an availability of a cached user interface state of the web application, which is stored in a datastore, is determined. In response to the determination that the cached user interface state is available, operations are performed. These operations include fetching the cached user interface state from the datastore and communicating the cached user interface state to the client device for use in displaying an initial user interface to a user by the client device. While the initial user interface is displayed to the user, the web application continues initializing in preparation to being fully operational.

In some examples, polling is used to determine an execution status of the web application. In response to the execution status indicating that the web application is in a ready state, the web application receives a results request from the client device for results from the web application where the results request is in response to an interaction by the user with the initial user interface. In response to receiving the results request, operations are performed. These operations include generating the results using the results request, communicating the results to the client device, and updating the cached user interface state using the results.

In some examples, the fetching of the cached user interface state comprises querying a metadata database to retrieve specified data of the cached user interface state.

In some examples, the initial user interface is updated using the results by modifying elements of the initial user interface that are displayed to the user without reloading the initial user interface.

In some examples, communications between the client device and the web application during the execution of the web application are validated using a user database role. The user database role determines a type of data included in the cached user interface state communicated to the client device.

In some examples, a sandbox process is employed to execute the web application, wherein the sandbox process restricts the computing environment of the web application.

In some examples, the cached user interface state is stored in a distributed file system and an integrity of the cached user interface state is checked before the cached user interface state is communicated to the client device.

In some examples, row-level security is applied to the cached user interface state communicated to the client device.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

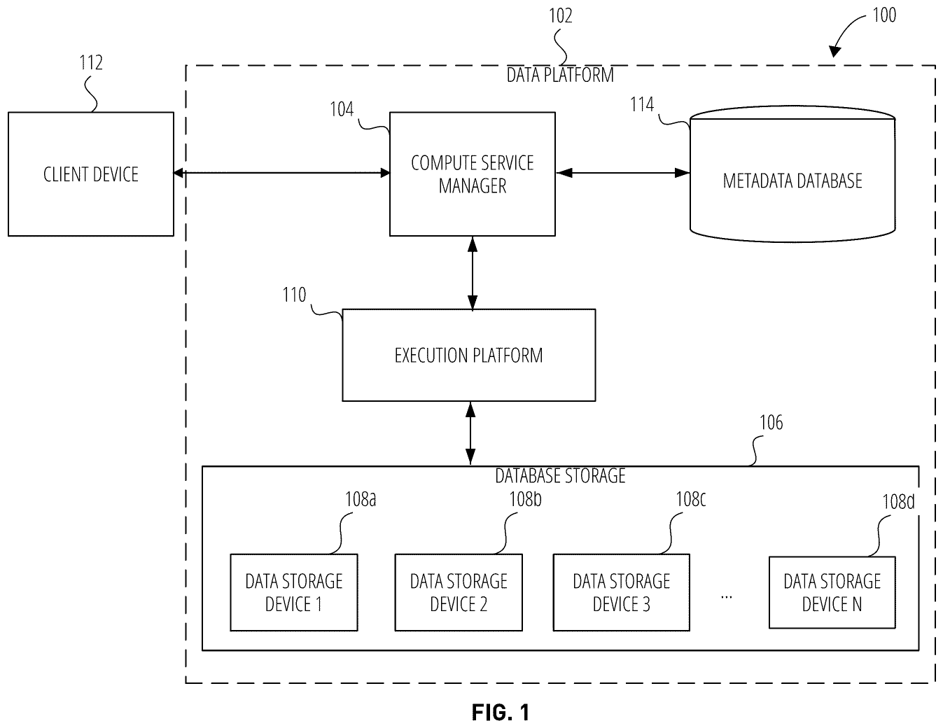

FIG. 1 illustrates an example computing environment 100 that includes a data platform 102 in communication with a client device 112, according to some examples. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a database storage 106, a compute service manager 104, an execution platform 110, and a metadata database 114. The database storage 106 comprises a plurality of computing machines and provides on-demand computer system resources such as data storage and computing power to the data platform 102. As shown, the database storage 106 comprises multiple data storage devices, namely data storage device 1 108a to data storage device N 108d. In some examples, the data storage devices 1 to N are cloud-based storage devices located in one or more geographic locations. For example, the data storage devices 1 to N may be part of a public cloud infrastructure or a private cloud infrastructure. The data storage devices 1 to N may be hard disk drives (HDDs), solid state drives (SSDs), storage clusters, Amazon S3TM storage systems or any other data storage technology. Additionally, the database storage 106 may include distributed file systems (e.g., Hadoop Distributed File Systems (HDFS)), object storage systems, and the like.

The data platform 102 is used for reporting and analysis of integrated data from one or more disparate sources including the storage devices 1 to N within the database storage 106. The data platform 102 hosts and provides data reporting and analysis services to multiple customer accounts. Administrative users can create and manage identities (e.g., users, roles, and groups) and use permissions to allow or deny access to the identities to resources and services. Generally, the data platform 102 maintains numerous customer accounts for numerous respective customers. The data platform 102 maintains each customer account in one or more storage devices of the database storage 106. Moreover, the data platform 102 may maintain metadata associated with the customer accounts in the metadata database 114. Each customer account includes multiple data objects with examples including users, roles, permissions, stages, and the like.

The compute service manager 104 coordinates and manages operations of the data platform 102. The compute service manager 104 also performs query optimization and compilation as well as managing clusters of compute services that provide compute resources (also referred to as “virtual warehouses”). The compute service manager 104 can support any number and type of clients such as end users providing data storage and retrieval requests, system administrators managing the systems and methods described herein, and other components/devices that interact with compute service manager 104. As an example, the compute service manager 104 is in communication with the client device 112. The client device 112 can be used by a user of one of the multiple customer accounts supported by the data platform 102 to interact with and utilize the functionality of the data platform 102.

The compute service manager 104 is also coupled to metadata database 114. The metadata database 114 stores data pertaining to various functions and aspects associated with the data platform 102 and its users. In some examples, the metadata database 114 includes a summary of data stored in remote data storage systems as well as data available from a local cache. Additionally, the metadata database 114 may include information regarding how data is organized in remote data storage systems (e.g., the database storage 106) and the local caches. The metadata database 114 allows systems and services to determine whether a piece of data needs to be accessed without loading or accessing the actual data from a storage device.

The compute service manager 104 is further coupled to the execution platform 110, which provides multiple computing resources that execute various data storage and data retrieval tasks. In some examples, the compute service manager 104 communicates with the execution platform 110 concerning jobs and tasks using a queue within the data platform 102. This isolates the operations of the execution platform 110 and the client device 112. The execution platform 110 is coupled to the database storage 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle all communication with a compute cluster for a given job provided by the compute service manager 104 and to communicate information back to the compute service manager 104 and other compute nodes of the execution platform 110.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices data storage device 1 108a to data storage device N 108d are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata database 114, execution platform 110, and database storage 106 are shown in FIG. 1 as individual discrete components. However, each of the compute service manager 104, metadata database 114, execution platform 110, and database storage 106 may be implemented as a distributed system (e.g., distributed across multiple systems/platforms at multiple geographic locations). Additionally, each of the compute service manager 104, metadata database 114, execution platform 110, and database storage 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the database storage 106. It is desirable to retrieve as much data as possible from caches within the execution platform 110 because the retrieval speed is typically faster than retrieving data from the database storage 106.

As shown in FIG. 1, the computing environment 100 separates the execution platform 110 from the database storage 106. In this arrangement, the processing resources and cache resources in the execution platform 110 operate independently of the database storage devices such as data storage device 1 108a, data storage device 2 108b, data storage device 3 108c, to data storage device N 108d in the database storage 106. Thus, the computing resources and cache resources are not restricted to a specific of the data storage device 1 108a to data storage device N 108d. Instead, all computing resources and all cache resources may retrieve data from, and store data to, any of the data storage resources in the database storage 106.

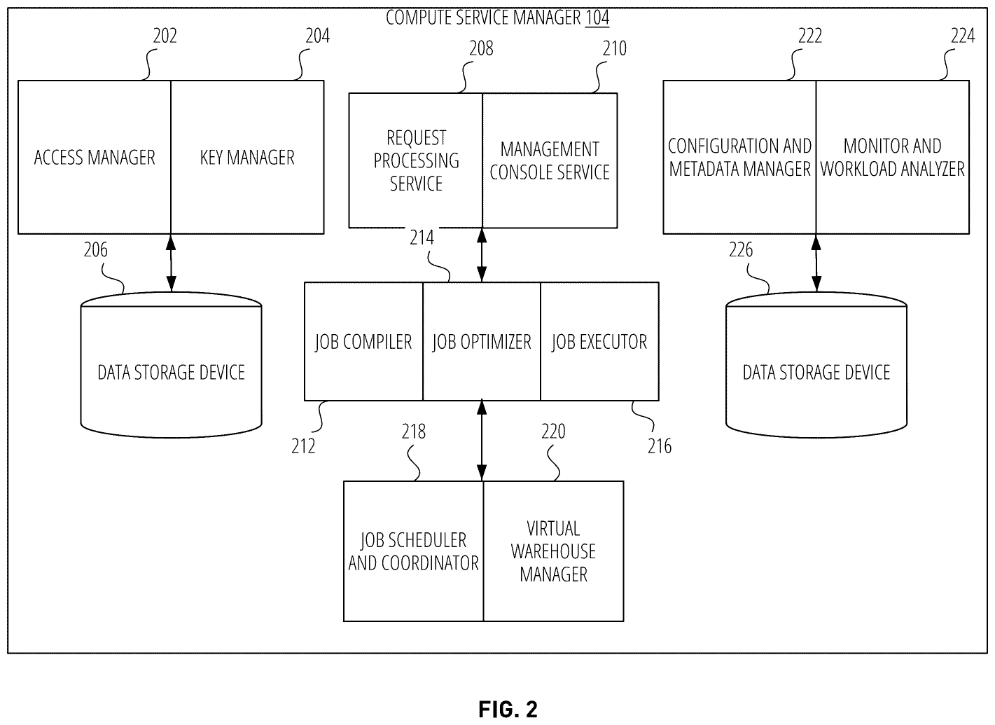

FIG. 2 is a block diagram illustrating components of the compute service manager 104, according to some examples. As shown in FIG. 2, the compute service manager 104 includes an access manager 202 and a key manager 204 coupled to a data storage device 206. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in database storage 106). As used herein, the remote storage devices may also be referred to as “persistent storage devices” or “shared storage devices.”

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in database storage 106.

A management console service 210 supports access to various systems and processes by administrators and other system managers. Additionally, the management console service 210 may receive a request to execute a job and monitor the workload on the system.

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 104.

A job scheduler and coordinator 218 sends received jobs to the appropriate services or systems for compilation, optimization, and dispatch to the execution platform 110. For example, jobs may be prioritized and processed in that prioritized order. In an example, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the compute service manager 104 includes a configuration and metadata manager 222, which manages the information related to the data stored in the remote data storage devices and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in database storage 106, or any other storage device.

The compute service manager 104 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 1 304a) may need to communicate with another execution node (e.g., execution node 2 304b), and should be disallowed from communicating with a third execution node (e.g., execution node 1 316a) and any such illicit communication can be recorded (e.g., in a log or other location). Also, the information stored on a given execution node is restricted to data relevant to the current query and any other data is unusable, rendered so by destruction or encryption where the key is unavailable.

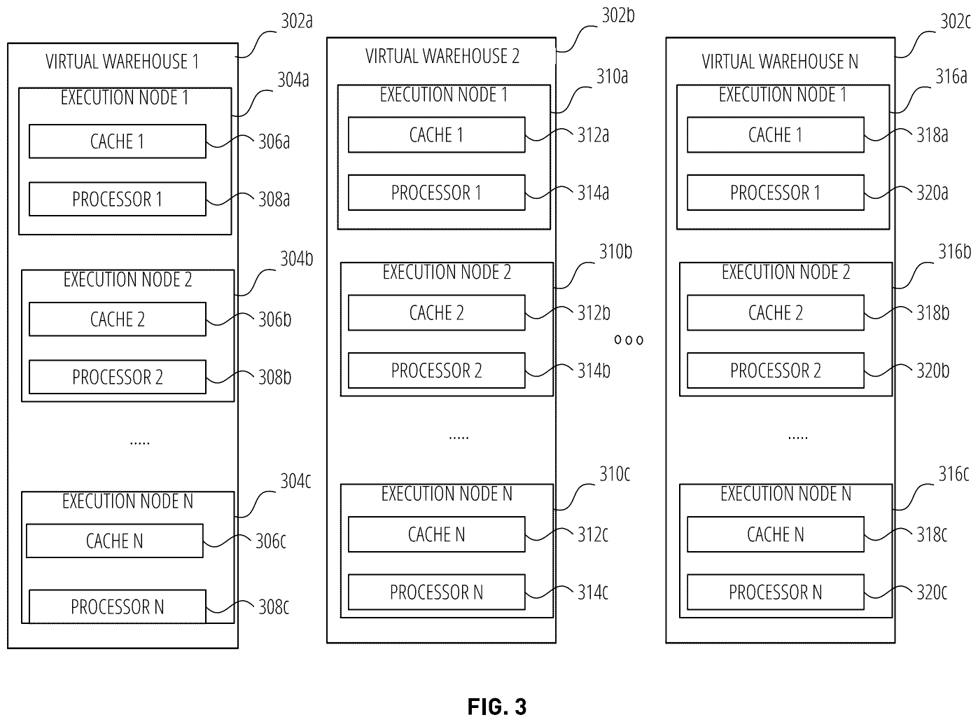

FIG. 3 is a block diagram illustrating components of the execution platform 110, according to some examples. As shown in FIG. 3, the execution platform 110 includes multiple virtual warehouses, including virtual warehouse 1 302a, and virtual warehouse 2 302b to virtual warehouse N 302c. Each virtual warehouse includes multiple execution nodes that each includes a data cache and a processor. The virtual warehouses can execute multiple tasks in parallel by using the multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in database storage 106).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 1 to N shown in FIG. 1. Thus, the virtual warehouses are not necessarily assigned to a specific data storage device 1 to N and, instead, can access data from any of the data storage devices 1 to N within the database storage 106. Similarly, each of the execution nodes shown in FIG. 3 can access data from any of the data storage devices 1 to N. In some examples, a particular virtual warehouse or a particular execution node can be temporarily assigned to a specific data storage device, but the virtual warehouse or execution node may later access data from any other data storage device.

In the example of FIG. 3, virtual warehouse 1 302a includes a plurality of execution nodes as exemplified by execution node 1 304a, execution node 2 304b, and execution node N 304c. Execution node 1 304a includes cache 1 306a and a processor 1 308a. Execution node 2 304b includes cache 2 306b and processor 2 308b. Execution node N 304c includes cache N 306c and processor N 308c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 302a discussed above, virtual warehouse 2 302b includes a plurality of execution nodes as exemplified by execution node 1 310a, execution node 2 310b, and execution node N 310c. Execution node 1 310a includes cache 1 312a and processor 1 314a. Execution node 2 310b includes cache 2 312b and processor 2 314b. Execution node N 310c includes cache N 312c and processor N 314c. Additionally, virtual warehouse N 302c includes a plurality of execution nodes as exemplified by execution node 1 316a, execution node 2 316b, and execution node N 316c. Execution node 1 316a includes cache 1 318a and processor 1 320a. Execution node 2 316b includes cache 2 318b and processor 2 320b. Execution node N 316c includes cache N 318c and processor N 320c.

In some examples, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more data storage devices in database storage 106. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the database storage 106.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 3 has multiple execution nodes. The multiple execution nodes associated with each virtual warehouse may be implemented using multiple computing systems at multiple geographic locations. For example, an instance of virtual warehouse 1 302a implements execution node 1 304a and execution node 2 304b on one computing platform at a geographic location and implements execution node N 304c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in database storage 106, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

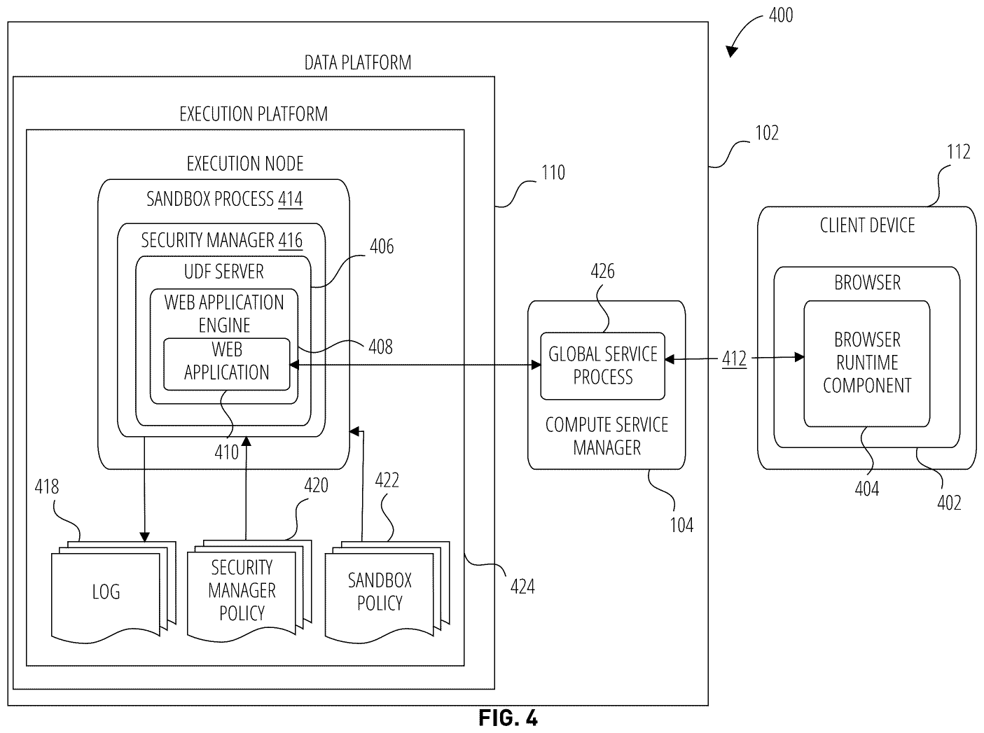

FIG. 4 is a deployment diagram of a computing environment 400 for providing a web application as a first-class database object in accordance with some examples. A data platform 102 utilizes the computing environment 400 to provide a secure framework for a web application 410 to be executed by an execution platform 110 of the data platform 102. The web application 410 and all of the components supporting the web application 410, such as, but not limited to, a web application engine 408 and a User Defined Function (UDF) server 406, collectively referred to as a “web application” herein, are treated by the data platform 102 as first-class database objects that can be instantiated using one or more commands within a database query as illustrated by the following example code fragments.

To create a new web application
CREATE [OR REPLACE] WEBAPP [IF NOT EXISTS]<webapp_name>
[VERSIONS] (versionList)
[WAREHOUSE=<warehouse_name>]
[COMMENT=‘<comment_string_literal>’]
versionList: =versionInfo [, versionInfo]
id=<webapp_version_name>
root_location=<app_root>
file_path=<file_name>

To drop a web application:
DROP WEBAPP [IF EXISTS]<webapp_name>

To alter an existing web application
ALTER WEBAPP [IF EXISTS]<webapp_name> SET
[WAREHOUSE=<warehouse_name>]
[DEFAULT_VERSION=<webapp_version_name>]
[COMMENT=‘<string_literal>’]
ALTER WEBAPP [IF EXISTS]<webapp_name>
ADD [(] versionList [)]
ALTER WEBAPP [IF EXISTS]<webapp_name>
DROP [(]<webapp_version_name> [,<webapp_version_name> . . . ] [)]
ALTER WEBAPP [IF EXISTS]<webapp_name> MODIFY
[(] modifywebapp VersionList [)]
modifywebapp VersionList: =
modifywebapp VersionAttr, [, modifywebapp VersionAttr] modifywebapp VersionAttr: =
[VERSION]<webapp_version_name>
SET {root_location=<app_root>| file_path=<file_name>}

Where:

<webapp_name> Specifies the identifier for the web application, unique for the schema it is created in.

<webapp_version_name> Specifies the identifier for the version of the web application.

<app_root> A reference to a stage URL that points to a root of the web application 410. When the user application runs, the files below this app_root will be available to the web application engine 408. Although versions can be in the same stage or data location within the data platform 102, separated only by prefixes it can be useful to have different stages per-version to manage permissions and cleanup better.

<file_name> A path to a user file to run as part of the web application engine 408. This is relative to the <app_root>.

<warehouse_name> A name of a virtual warehouse, such as virtual warehouse 1 302a of the data platform 102 to run the web application 410.

<comment_string_literal> Comment describing the web application 410.

A partial list of permissions enforced by the security manager policy 420 and/or the sandbox policy 422 for the web application 410 and its supporting components are described in Table 1 and Table 2:

TABLE 1

| Privilege | Usage |
|---|---|
| CREATE WEBAPP | The ability to create a web application 410 and |
| | its associated components in a schema. |

TABLE 2

| Privilege | Usage |
|---|---|
| USAGE | Enables hitting the HTTPS endpoint for the |
| | web application 410 on the default version. |
| | Enables seeing the web application using |
| | DESCRIBE or SHOW commands |
| ALL [PRIVILEGES] | Grant all privileges other than OWNERSHIP |
| OWNERSHIP | Grants full control over the web application; |
| | required to drop the web application 410. |
| | Only a single role can hold this privilege |
| | on a specific object at a time |

In some examples, there are objects of the data platform 102 that the web application 410 depends on, such as, but not limited to, a storage location or stage for storing files, and a virtual warehouse, such as virtual warehouse 1 302a, within which the web application 410 is loaded. When creating a web application 410 and its associated components that reference a stage, the web application 410 inherits READ permissions to that stage and USAGE permissions to the virtual warehouse.

In some examples, the web application has direct access to source files that define the operations of the web application, but a user of the web application does not have the same permissions to access the source files. The web application accesses the source files via the stage.

In some examples, if a stage's permissions are changed after a web application 410 is created, such that the owner of the web application 410 no longer has permissions to it, then requests to the web application 410 will fail with an error stating that the web application 410 does not exist. If a Warehouse's permissions are changed after the web application 410 is created, then the logic for the warehouse to use will act as if no warehouse was set.

In some examples, a stage or data location is embedded in the web application 410 or one of its associated components and the permissions to the web application 410 and the permissions of the stage are associated together. In some examples, a web application 410 and its related components may be shared with other owners or users in accordance with permissions stored in the security manager policy 420 and/or sandbox policy 422.

Accordingly, when instantiated, the web application 410 and all of its supporting components inherit all of the attributes of a first-class object within a database provided by the data platform 102 including permissions and restrictions that may be utilized by the data platform 102 to manage a database object. In some examples, the web application 410 is provided as a service by the UDF server 406 utilizing the web application engine 408 and can be accessed over a network, such as the Internet, by a browser runtime component 404 included in a browser 402 hosted by a client device 112 utilizing protocols that are used to access documents and files on the World Wide Web.

As described in reference to FIG. 2, the compute service manager 104 implements security protocols that validate all communication from the execution platform 110 to validate that the content and context of that communication are consistent with the task(s) known to be assigned to the execution platform 110. For example, the execution platform 110 executing a query A is not allowed to request access to a particular data source (e.g., data storage device 226 or any one of the storage devices in the database storage 106) that is not relevant to query A. In an example, an execution node 424 may need to communicate with a second execution node but the security mechanisms described herein can disallow communication with a third execution node. Moreover, any such illicit communication can be recorded (e.g., in a log 418 or other location). Further, the information stored on a given execution node is restricted to data relevant to the current query and any other data is unusable by destruction or encryption where the key is unavailable.

In some examples, the UDF server 406 and its components, such as the web application engine 408 and the web application 410 are implemented in a particular programming language such as Python, and the like. In some examples, the web application browser runtime component 404 is implemented in a different programming language (e.g., C or C++) than the UDF server 406, which can further improve security of the computing environment 400 by using a different codebase (e.g., one without the same or fewer potential security exploits).

The UDF server 406 receives communications from the web application browser runtime component 404 via a global service process 426 of the data platform 102. The global service process 426 is responsible for receiving requests from the Browser runtime component 404. The global service process 426 uses components of the compute service manager 104 to perform various authentication tasks including a first level of authorization using an access manager 202 of the compute service manager 104. The UDF server 406 performs tasks including assigning processing threads to execute user code of the web application 410 and returning the results generated by the web application 410 to the web application browser runtime component 404 via the global service process 426.

In some examples, the UDF server 406 executes within a sandbox process 414 as more fully described below. In some examples, the UDF server 406 is implemented in Python interpreted by an interpreter process. In some examples, the UDF server 406 is implemented in another language, such as Java, executed by a virtual machine (JVM). Since the UDF server 406 advantageously executes in a separate process relative to the browser 402, there is a lower risk of malicious manipulation of the web application 410.

Results of performing an operation, among other types of information or messages, can be stored in a log 418 for review and retrieval. In some examples, the log 418 can be stored locally in memory at the execution node 424, or at a separate location such as the database storage 106.

In some examples, a security manager 416, can prevent completion of an operation from a web application 410 by throwing an exception (e.g., if the operation is not permitted), or returns (e.g., doing nothing) if the operation is permitted. In an implementation, the security manager 416 is implemented as a security manager object that allows an application to implement a security policy such as a security manager policy 420 and enables the application to determine, before performing a possibly unsafe or sensitive operation, what the operation is and whether it is being attempted in a security context that allows the operation to be performed. The security manager policy 420 can be implemented as a file with permissions that the UDF server 406 is granted. The UDF server 406 therefore can allow or disallow the operation based at least in part on the security policy.

In some examples, the sandbox process 414 reduces the risk of security breaches by restricting the computing environment of untrusted applications using security mechanisms such as namespaces and secure computing modes (e.g., using a system call filter to an executing process and all its descendants, thus reducing the attack surface of the kernel of a given operating system). Moreover, in an example, the sandbox process 414 is a lightweight process and is optimized (e.g., closely coupled to security mechanisms of a given operating system kernel) to process a database query or other service request in a secure manner within the sandbox environment.

In some examples, the sandbox process 414 can utilize a virtual network connection in order to communicate with other components within the computing environment 400. A specific set of rules can be configured for the virtual network connection with respect to other components of the computing environment 400. For example, such rules for the virtual network connection can be configured for a particular UDF server 406 to restrict the locations (e.g., particular sites on the Internet or components that the UDF server 406 can communicate) that are accessible by operations performed by the UDF server 406. Thus, in this example, the UDF server 406 can be denied access to particular network locations or sites on the Internet.

The sandbox process 414 can be understood as providing a constrained computing environment for a process (or processes) within the sandbox, where these constrained processes can be controlled and restricted to limit access to certain computing resources.

Examples of security mechanisms can include the implementation of namespaces in which each respective group of processes executing within the sandbox environment has access to respective computing resources (e.g., process IDs, hostnames, user IDs, file names, names associated with network access, and inter-process communication) that are not accessible to another group of processes (which may have access to a different group of resources not accessible by the former group of processes), other container implementations, and the like. By having the sandbox process 414 execute as a sub-process, in some examples, latency in processing a given database query can be substantially reduced in comparison with other techniques that may utilize a virtual machine solution by itself.

As further illustrated, the sandbox process 414 can utilize a sandbox policy 422 to enforce a given security policy. The sandbox policy 422 can be a file with information related to a configuration of the sandbox process 414 and details regarding restrictions, if any, and permissions for accessing and utilizing system resources. Example restrictions can include restrictions to network access, or file system access (e.g., remapping file system to place files in different locations that may not be accessible, other files can be mounted in different locations, and the like). The sandbox process 414 restricts the memory and processor (e.g., CPU) usage of the UDF server 406, ensuring that other operations on the same execution node can execute without running out of resources.

The web application browser runtime component 404 provides a frontend for the web application 410. The web application browser runtime component 404 performs browser interactions with the data platform 102 for the web application 410. Components of the computing environment 400 communicate using a communication channel 412 that provides a set of commands that are used for interactions between the web application 410 and the browser 402. The communication channel 412 logically interacts with the web application 410, and physically goes through the layers of the data platform 102 to ensure security restrictions and policies are enforced at each layer. These may include permissions or runtime requirements from the compute service manager 104.

In some examples, communication between the browser runtime component 404 and the web application 410 uses a structured messaging system. During execution, the web application 410 generates messages. These messages carry and directives used for constructing specific elements within the browser runtime component 404. For example, when a command to display a chart is executed, the web application 410 dispatches a message containing the chart's data and associated metadata to the browser runtime component 404. The browser runtime component 404 then uses this information to render the chart for the user.

In some examples, interactivity within web applications is handled through interactive widgets such as, but not limited to, buttons, sliders, and the like. User interactions with these widgets trigger the browser runtime component 404 to send messages to the web application 410. These messages inform the web application 410 of the user's actions. Upon receiving such messages, the web application 410 may alter the application's data or state in response to the user's inputs and subsequently sends updated messages back to the browser runtime component 404. This allows the browser runtime component 404 to refresh the user interface to reflect the updated application state.

In some examples, a session state management system is used that preserves an application state across multiple script reruns. This feature is useful when the script is re-executed due to user interactions or other triggers. The session state is maintained through messages that relay state information between the browser runtime component 404 and the web application 410, ensuring continuity and consistency in the user experience. In some examples, the web application 410 caches the messages in a datastore. These cached messages may be accessed by the global service process 426 to generate an initial response during a launch of the web application 410.

The web application browser runtime component 404 sends back messages that are processed by the execution platform 110 and responded to with a series of forward messages.

The web application engine 408 includes instructions that can be defined by third parties but arc run as an application within the execution platform 110. The web application engine 408 provides programming frameworks that users can build applications, such as the web application 410. In some examples, the web application engine 408 is written in Python and is treated by the execution platform 110 as special Python stored procedures. In some examples, the web application engine 408 is written in another language, such as, but not limited to Java, and hosted by a virtual machine within the execution platform 110. In some examples, third parties may build their own web application engines.

The web application 410 comprises an application written by an end user and evaluated by the web application engine 408. In some examples, the web application 410 comprises Python files that are evaluated by a proprietary Python interpreter.

The UDF server 406 is in charge of running UDFs in a controlled execution environment such as the sandbox process 414. In some examples, the UDF server 406 comprises a Python UDF server. In some examples, the UDF server 406 utilizes other languages, such as Java.

In some examples, a Uniform Resource Locator (URL) identification of an assigned to the UDF server 406 is a unique value that is stable across replications of the UDF server 406. For example, the URL identification is a randomly generated string that is unique within an account of an owner. The URL identification may be created by using a UUID4 and Base64 encoding to give it a more concise representation.

In some examples, a schema object of the data platform 102 is used to define the components of the web application such as, but not limited to, the UDF server 406, the web application engine 408, the web application 410, and the web application browser runtime component 404. The name, network endpoint, permissions and policies are based on this object. In some examples, the schema object includes a particular version of a web application engine 408 to use as well as any resource constraints.

In some examples, version of a user's code is specified and will associate a named version of a web application that refers to a place on a storage location or stage used by the data platform 102 to run user code.

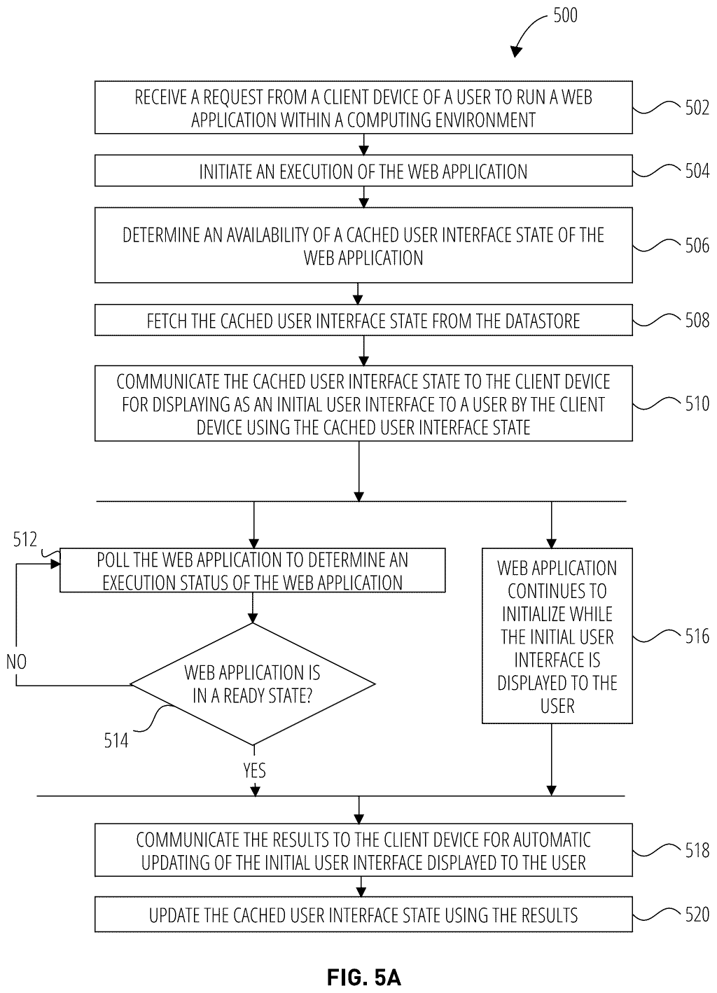

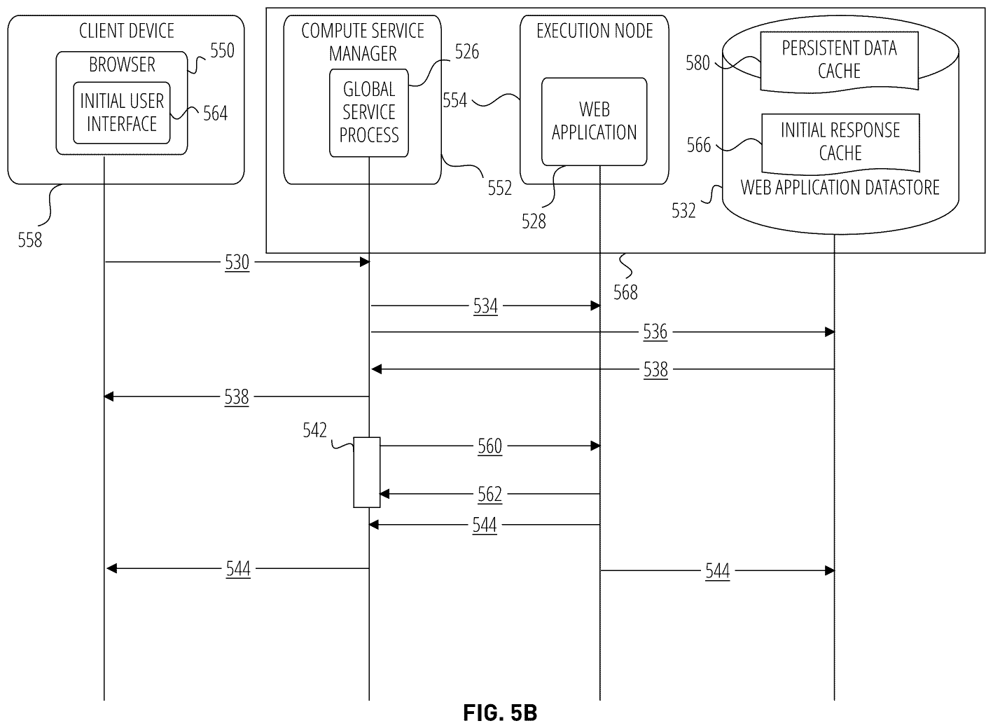

FIG. 5A illustrates an example initial response cache method 500 and FIG. 5B illustrates a sequence of operations of the initial response cache method 500, according to some examples. Although the example initial response cache method 500 depicts a particular sequence of operations, the sequence of operations may be altered without departing from the scope of the present disclosure. For example, some of the operations depicted may be performed in parallel or in a different sequence that does not materially affect the function of the initial response cache method 500. In other examples, different components of a data platform 102 that implements the initial response cache method 500 may perform functions at substantially the same time or in a specific sequence.

A data platform 568 hosts a compute service manager 552 and an execution node 554 as more fully described in reference to FIG. 2 and FIG. 3. In operation 502, a global service process 526 of the compute service manager 552 receives a run request 530 from a browser 550 hosted by a client device 558 of a user to initiate an execution of a web application 528. In some examples, the global service process 526 processes the run request 530 by initiating the protocols to launch the web application 528. This involves allocating the required resources and preparing the environment for the web application to operate efficiently.

In operation 504, the global service process 526 initiates 534 (of FIG. 5B) an execution of the web application 528 by an execution node 554 (of FIG. 5B). In some examples, the initiation process involves the global service process 526 sending a command to the execution node 554, which is configured to handle the computational tasks required by the web application 528. This command includes parameters and configurations needed for the web application 528 to properly initialized.

The execution node 554 receives the initiation command and allocates the appropriate resources, such as memory and processing power, to support the operation of the web application 528. The execution node 554 proceeds to load the code of the web application 528 and begins processing the tasks as defined by the operational logic of the web application 528.

In operation 506, the global service process 526 determines an availability of an initial response cache 566 of the web application 528 stored in a web application datastore 532. For example, the global service process 526 queries the web application datastore 532 to check if a cached version of a user interface state exists of a user interface of the web application 528. This involves sending a request to the web application datastore 532, which then searches its records to find any cached data associated with the web application 528.

In some examples, the initial response cache 566 may include a variety of user interface elements and data types that are used for rendering an initial user interface 564 of the web application 528 efficiently upon a user's access. The initial response cache 566 includes, but is not limited to, serialized versions of the user interface state, which can include both static and dynamic content as generated during previous sessions of the web application.

The initial response cache 566 stores a comprehensive snapshot of the user interface of the web application 528 user interface and associated data, enabling a seamless and efficient user experience during subsequent accesses of the web application 528. In some examples, the types of messages stored within the initial response cache 566 can include, but are not limited to, HTML content, JavaScript objects, and CSS settings that define the layout and style of the user interface. These messages ensure that the visual elements of the initial user interface 564 of the web application 528, such as buttons, menus, text fields, and graphics, are quickly loaded and displayed to the user without the need for real-time rendering or data fetching.

In some examples, the initial response cache 566 can contain data objects that represent the state of various interactive elements within the application. By way of example, dropdown menus might store their last selected values, input fields might hold text entered during a previous session, and data tables might include sorting and filtering settings applied by the user. This allows for a personalized and responsive user experience, as the initial user interface 564 can display previously interacted states immediately while the web application 528 is initializing.

In some examples, the initial response cache 566 can also include system messages that are used to communicate the status of the web application to the user. These can include, but are not limited to, notifications about the availability of new data, alerts regarding system updates, or messages that confirm successful actions taken by the user.

In some examples, in terms of data types, a persistent data cache 580 is used to store serialized data structures such as arrays, objects, or encoded binary data. This data is used for web applications that display complex datasets or perform data-intensive operations. By caching this data, the initial user interface 564 can be displayed to the user without costly re-computations or database queries, thereby speeding up the user's interaction with the web application 528.

In some examples, the initial response cache 566 stores the UI elements used for the initial user interface 564 and the persistent data cache 580 stores backend data that was used to render the UI elements and the initial response cache 566 and the persistent data cache 580 are synchronized. This arrangement provides a fast initial response, but later interactions for viewing and interacting with the backend data can also be fast with a consistent set of interactions across the initial response cache 566 and the persistent data cache 580.

In operation 508, the global service process 526 fetches 536 a cached user interface state from the initial response cache 566 stored on the web application datastore 532. In some examples, the cached user interface state includes, but is not limited to, cached user interface messages 538 that were communicated by the web application 528 to a browser during a previous session. In some examples, the performance of the retrieval process is tuned to ensure quick access to the cached user interface state. The cached user interface state includes elements such as, but not limited to, layout configurations, user-specific settings, pre-loaded data, and the like, allowing the global service process 526 to provide an initial user interface 564 of the web application 528 to the user during the initialization of the web application 528.

In operation 510, the global service process 526 communicates the cached user interface messages 538 of the cached user interface state stored in the initial response cache 566 to the browser 550 of the client device 558. The browser 550 receives the cached user interface messages 538 and uses the cached user interface messages 538 to generate the initial user interface 564 and displays the initial user interface 564 to the user. In some examples, the communication process includes the global service process 526 selecting appropriate cached user interface messages 538 from the initial response cache 566, where they are stored. These messages contain pre-rendered data and layout information that represent the user interface state of the web application 528 when the web application 528 was last executed.

In some examples, a connection status is displayed in a navigation bar of the global service process 526 informing the user that they are viewing a cached version of the web application 528.

In some examples, while the initial user interface 564 is displayed, the user can see and interact with the cached content of the persistent data cache 580 but be limited in terms of full web application functionality until the initialization of the web application 528 is complete.

In some examples, user interface elements of the initial user interface 564 such as buttons or links can be displayed in a grayed-out state or show animations such as a running man or the like, indicating that the web application 528 is still initializing in the background.

In additional examples, once the cached user interface messages 538 are retrieved, they are transmitted over a secure network connection to the browser 550. The browser 550 then uses these messages to reconstruct and display the initial user interface 564 without needing to wait for the web application 528 to be fully initialized and operational to receive and process requests from the browser 550. This method significantly speeds up the user's interaction with the web application 528, providing an immediate and seamless experience by utilizing previously stored data from a previous execution of the web application 528.

In operation 516, the web application 528 continues to initialize while the initial user interface is displayed to the user by the browser 550. In some examples, this involves the web application 528 initializing itself and preparing a set of initial web application results messages 544 by performing backend tasks, computations, data updates, and the like that are useful for the full functionality of the web application 528. This process runs concurrently with the user's interaction with the already displayed initial user interface 564 being displayed by the browser 550.

Concurrently as the web application 528 is being initialized, the global service process 526 polls 542 the execution node 554 for data of an execution status 562 of the web application 528. For example, in operation 512, the global service process 526 communicates a status request 560 to the execution node 554 requesting data of the execution status 562 of the web application 528. In some examples, this polling involves the global service process 526 sending periodic requests to the execution node 554. These requests are designed to retrieve current status information about the execution of the web application 528, such as whether it is fully initialized and ready to receive requests, is idle, or has encountered any errors.

In operation 514, the global service process 526 determines if the execution status indicates the web application 528 has been initialized and is ready to receive and process request messages from the browser 550. For example, this determination involves analyzing the data of the execution status 562 received from the execution node 554. The global service process 526 assesses various parameters of the data of the execution status 562 such as system readiness, resource availability, and any potential error flags that might affect the operation of the web application 528. When the analysis of the execution status 562 confirms that all systems are operational and the web application 528 is prepared to respond to user input and requests, the global service process 526 proceeds with the next steps in the workflow of the web application 528. This can include initiating user interactions, starting data processing tasks, enabling further functionalities for the web application 528, and the like.

In operation 518, the web application 528 begins full execution and communicates the web application results messages 544 to the browser 550 via the global service process 526 for automatic updating of the initial user interface displayed to the user by the browser 550.

In some examples, once the web application 528 is fully functional and completes its loading, the user interface elements of the initial user interface 564 elements are activated (no longer grayed out), and the user can interact with the web application 528 through the initial user interface 564 as normal. The status notification changes to indicate that the web application 528 is fully operational and available through the initial user interface 564. Any interaction with the web application 528 now triggers a fresh run of the web application 528, fetching and displaying the latest data and state.

In some examples, if the web application 528 fails to become fully operational, the initial user interface 564 displays an error message to the user.

Simultaneously with communicating the web application results messages 544 to the browser 550, in operation 520, the web application 528 updates the initial response cache 566 and the persistent data cache 580 stored in the web application datastore 532 using the web application results messages 544.

In some examples, web application 528 receives a results request from the browser 550 for results of an operation of the web application where the results request is in response to an interaction by the user with the initial user interface 564. In response to the results request, the web application 528 generates the requested results and communicates data of the results as results messages to the browser 550 for automatic updating of the initial user interface 564. In addition, the web application 528 updates the initial response cache 566 and the persistent data cache 580 stored in the web application datastore 532 using the results messages.

In some examples, when the global service process 526 fetches the initial response cache 566 from the web application datastore 532, the global service process 526 queries a metadata database to retrieve specified data of the initial response cache 566. For example, the global service process 526 operates by initiating a query to the metadata database upon receiving a request to fetch the initial response cache 566. This query is specifically designed to retrieve detailed attributes associated with the initial response cache 566 and the persistent data cache 580 stored within the web application datastore 532. The metadata database, which stores comprehensive data about various states and configurations, provides information to ensure that the fetched user interface state is current and accurate. This process not only enhances the efficiency of data retrieval but also ensures that the user interface presented to the client device is reflective of the most recent interactions and data states, thereby maintaining the integrity and relevance of the user experience.

In some examples, during an update to the initial user interface 564 by the browser 550 using the web application results messages 544, elements of the initial user interfaces 564 are modified and displayed to the user without reloading the initial user interface 564. For example, during the process of updating the initial user interface 564, the browser 550 receives web application results messages 544, which contain data and commands for updating specific elements of the initial user interface 564. These updates are applied directly to the existing elements of the initial user interface 564, such as text fields, charts, or tables, without the need for a complete page reload. This method enhances the user experience by providing seamless and immediate visual feedback based on the latest data, ensuring that the user interface remains dynamic and responsive to user interactions or underlying data changes. This approach minimizes disruption and maintains the continuity of the user's interaction with the application.

In some examples, communications between the browser 550 and the web application 528 during the execution of the web application 528 are validated using a user database role. For example, during the execution of the web application 528, communications between the browser 550 and the application are subject to validation processes that utilize a user database role. This role defines the permissions and access levels of the user interacting with the web application 528. Each communication or request sent from the browser 550 to the web application 528 is checked against the permissions associated with the user's role in the database. This ensures that users can only execute actions or access data that their roles permit, enhancing the security and integrity of the web application 528 by preventing unauthorized access or operations. This role-based validation is useful for maintaining a secure and compliant operational environment within the web application 528.

In some examples, a user database role determines a type of data included in the cached user interface messages 538 communicated to the browser 550 for display in the initial user interface 564. For example, a user database role plays a role in determining the type of data included in the cached user interface messages 538 that are communicated to the browser 550. This role-based data filtering provides that the information sent to the browser 550 is appropriate and authorized for the specific user's access level. As an example, if a user's database role grants them access to only a subset of data provided by the web application 528, the cached user interface messages 538 prepared for that user will only include the data the use is permitted to view. This mechanism not only upholds data security protocols but also personalizes the user experience by tailoring the data visibility according to user privileges and roles. This approach is useful for maintaining data confidentiality and compliance with data access policies. As another examples, a user with a finance role within an organization would be permitted to view any financial information in the initial user interface 564 but would be prevented from viewing any personal data of employees that might be initial user interface 564.

In some examples, the initial response cache 566 and the persistent data cache 580 are stored in a distributed database system and are checked for integrity before the contents of the initial response cache 566 and persistent data cache 580 are communicated to the browser 550. For example, when the initial response cache 566 and the persistent data cache 580 are stored within a distributed database system, the initial response cache 566 and the persistent data cache 580 undergo an integrity check before being communicated to the browser 550. This process involves verifying that the data has not been altered or corrupted since it was initially cached. The integrity checks use methodologies including, but not limited to, checksums, hashes, other cryptographic methods, and the like to ensure that the cached data matches its expected state. If the integrity checks are passed, the messages included in the cached user interface messages 538 are then communicated to the browser 550, ensuring that the user receives accurate and untampered data. This step is useful for maintaining the reliability and trustworthiness of the data presented to the user, especially in environments where data integrity is useful for decision-making or compliance.

In some examples, a row-level security policy is applied to the messages of the initial response cache 566 and the persistent data cache 580 communicated to the browser 550. For example, when applying a row-level security policy to the messages of the initial response cache 566 or the persistent data cache 580, the data platform 568 ensures that each piece of data communicated to the browser 550 adheres to specific access controls associated with the user's credentials. This security measure filters the data at a granular level, allowing only authorized rows of data to be included in the cached messages based on the user's role or permissions. For instance, if the initial response cache 566 or the persistent data cache 580 contain data from multiple departments within a company, the row-level security policy will ensure that a user from the marketing department will only receive cached messages containing marketing-related data, excluding any data from finance or human resources. This targeted data delivery enhances security by guarding against unauthorized access to sensitive information to help ensure compliance with data governance standards.

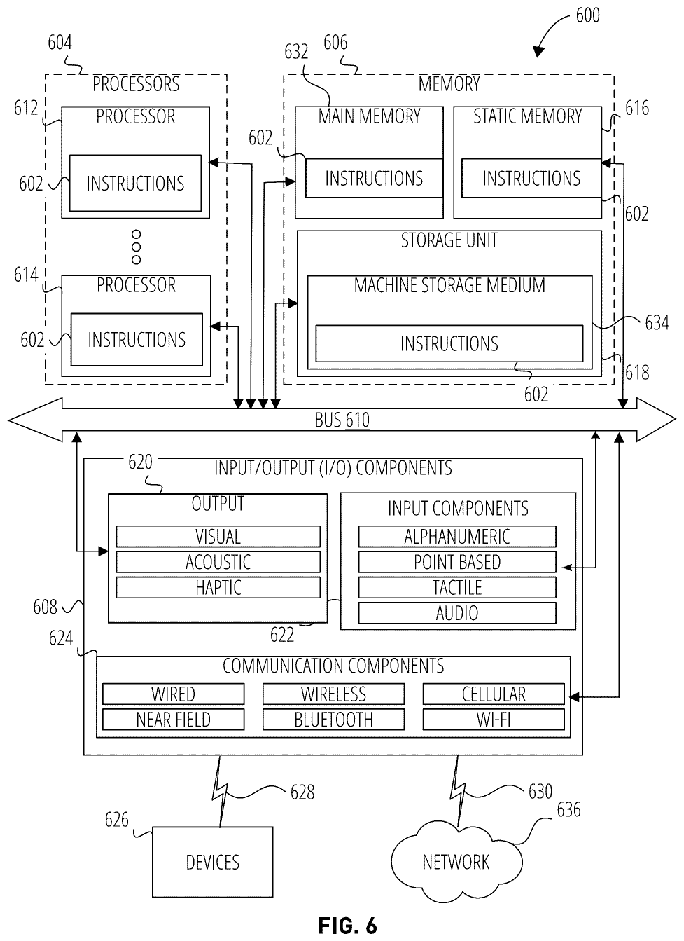

FIG. 6 illustrates a diagrammatic representation of a machine 600 in the form of a computer system within which a set of instructions may be executed to cause the machine 600 to perform any one or more of the methodologies discussed herein, according to some examples. Specifically, FIG. 6 shows a diagrammatic representation of the machine 600 in the example form of a computer system, within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more operations of any one or more of the methods described herein. In this way, the instructions 602 transform a general, non-programmed machine into a particular machine 600 (e.g., the compute service manager 104, the execution platform 110, and the data storage devices 1 to N of database storage 106) that is specially configured to carry out any one of the described and illustrated functions in the manner described herein.

In alternative examples, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 602, sequentially or otherwise, that specify actions to be taken by the machine 600. Further, while only a single machine 600 is illustrated, the term “machine” shall also be taken to include a collection of machines that individually or jointly execute the instructions 602 to perform any one or more of the methodologies discussed herein.

The machine 600 includes hardware processors 604, memory 606, and I/O components 608 configured to communicate with each other such as via a bus 610. In an example, the processors 604 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, multiple processors as exemplified by processor 612 and a processor 614 that may execute the instructions 602. The term “processor” is intended to include multi-core processors that may comprise two or more independent processors (sometimes referred to as “cores”) that may execute instructions 602 contemporaneously. Although FIG. 6 shows multiple processors 604, the machine 600 may include a single processor with a single core, a single processor with multiple cores (e.g., a multi-core processor), multiple processors with a single core, multiple processors with multiple cores, or any combination thereof.

The memory 606 may include a main memory 632, a static memory 616, and a storage unit 618 including a machine storage medium 634, all accessible to the processors 604 such as via the bus 610. The main memory 632, the static memory 616, and the storage unit 618 store the instructions 602 embodying any one or more of the methodologies or functions described herein. The instructions 602 may also reside, completely or partially, within the main memory 632, within the static memory 616, within the storage unit 618, within at least one of the processors 604 (e.g., within the processor's cache memory), or any suitable combination thereof, during execution thereof by the machine 600.

The input/output (I/O) components 608 include components to receive input, provide output, produce output, transmit information, exchange information, capture measurements, and so on. The specific I/O components 608 that are included in a particular machine 600 will depend on the type of machine. For example, portable machines such as mobile phones will likely include a touch input device or other such input mechanisms, while a headless server machine will likely not include such a touch input device. It will be appreciated that the I/O components 608 may include many other components that are not shown in FIG. 6. The I/O components 608 are grouped according to functionality merely for simplifying the following discussion and the grouping is in no way limiting. In various examples, the I/O components 608 may include output components 620 and input components 622. The output components 620 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 622 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 608 may include communication components 624 operable to couple the machine 600 to a network 636 or devices 626 via a coupling 630 and a coupling 628, respectively. For example, the communication components 624 may include a network interface component or another suitable device to interface with the network 636. In further examples, the communication components 624 may include wired communication components, wireless communication components, cellular communication components, and other communication components to provide communication via other modalities. The devices 626 may be another machine or any of a wide variety of peripheral devices (e.g., a peripheral device coupled via a universal serial bus (USB)). For example, as noted above, the machine 600 may correspond to any one of the compute service manager 104, the execution platform 110, and the devices 626 may include the data storage device 226 or any other computing device described herein as being in communication with the data platform 102 or the database storage 106.

The various memories (e.g., 606, 616, 632, and/or memory of the processor(s) 604 and/or the storage unit 618) may store one or more sets of instructions 602 and data structures (e.g., software) embodying or utilized by any one or more of the methodologies or functions described herein. These instructions 602, when executed by the processor(s) 604, cause various operations to implement the disclosed examples.

Described implementations of the subject matter can include one or more features, alone or in combination as illustrated below by way of example.

Example 1 is a method, comprising: receiving a request from a client device of a user to run a web application within a computing environment; initiating an execution of the web application; determining an availability of a cached user interface state of the web application, the cached user interface state stored in a datastore; in response to determining the cached user interface state is available, performing operations comprising: fetching the cached user interface state from the datastore; communicating the cached user interface state to the client device for displaying a user interface to a user by the client device using the cached user interface state; and continuing to execute the web application while the user interface is displayed to the user.

In Example 2, the subject matter of Example 1 includes, polling the web application to determine an execution status of the web application; and in response to the execution status indicating the web application is in a ready state, performing operations comprising: receiving a results request from the client device for results from the web application, the results request in response to an interaction by the user with the user interface; in response to receiving the results request, performing operations comprising: generating the results using the results request; communicating the results to the client device; and updating the cached user interface state using the results.

In Example 3, the subject matter of any of Examples 1-2 includes, wherein fetching the cached user interface state comprises querying a metadata database to retrieve specified data of the cached user interface state.

In Example 4, the subject matter of any of Examples 1-3 includes, wherein updating the user interface using the results comprises modifying elements of the user interface that are displayed to the user without reloading the initial user interface.

In Example 5, the subject matter of any of Examples 1-4 includes, validating communications between the client device and the web application during the execution of the web application using a user database role.

In Example 6, the subject matter of any of Example 1-5 includes, wherein the user database role determines a type of data included in the cached user interface state communicated to the client device.

In Example 7, the subject matter of any of Examples 1-6 includes, employing a sandbox process to execute the web application, the sandbox process restricting the computing environment of the web application.

In Example 8, the subject matter of any of Examples 1-7 includes, wherein the cached user interface state is stored in a distributed file system, and the method further comprises checking an integrity of the cached user interface state before the cached user interface state is communicated to the client device.

In Example 9, the subject matter of any of Examples 1-8 includes, establishing a virtual network connection that restricts access of the web application to network resources based on a sandbox policy.

In Example 10, the subject matter of any of Examples 1-9 includes, applying row-level security to the cached user interface state communicated to the client device.

Example 11 is at least one machine-readable medium including instructions that, when executed by processing circuitry, cause the processing circuitry to perform operations to implement of any of Examples 1-10.

Example 12 is an apparatus comprising means to implement of any of Examples 1-10.

Example 13 is a system to implement of any of Examples 1-10.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 636 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 636 or a portion of the network 636 may include a wireless or cellular network, and the coupling 630 may be a Code Division Multiple Access (CDMA) connection, a Global System for Mobile communications (GSM) connection, or another type of cellular or wireless coupling. In this example, the coupling 630 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 602 may be transmitted or received over the network 636 using a transmission medium via a network interface device (e.g., a network interface component included in the communication components 624) and utilizing any one of a number of well-known transfer protocols (e.g., hypertext transfer protocol (HTTP)). Similarly, the instructions 602 may be transmitted or received using a transmission medium via the coupling 628 (e.g., a peer-to-peer coupling) to the devices 626. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 602 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A method, comprising:
receiving a request from a client device of a user to run a web application within a computing environment;
initiating an execution of the web application;
determining an availability of a cached user interface state of the web application, the cached user interface state stored in a datastore;
in response to determining the cached user interface state is available, performing operations comprising:
fetching the cached user interface state from the datastore;
communicating the cached user interface state to the client device for displaying an initial user interface to a user by the client device using the cached user interface state; and
continuing to execute the web application while the initial user interface is displayed to the user.

2. The method of claim 1, further comprising:
polling the web application to determine an execution status of the web application; and
in response to the execution status indicating the web application is in a ready state, performing operations comprising:
receiving a results request from the client device for results from the web application, the results request in response to an interaction by the user with the initial user interface;
in response to receiving the results request, performing operations comprising:
generating the results using the results request;
communicating the results to the client device; and
updating the cached user interface state using the results.

3. The method of claim 1, wherein fetching the cached user interface state comprises querying a metadata database to retrieve specified data of the cached user interface state.

4. The method of claim 2, wherein updating the initial user interface using the results comprises modifying elements of the initial user interface that are displayed to the user without reloading the initial user interface.

5. The method of claim 1, further comprising validating communications between the client device and the web application during the execution of the web application using a user database role.

6. The method of claim 5, wherein the user database role determines a type of data included in the cached user interface state communicated to the client device.

7. The method of claim 1, further comprising employing a sandbox process to execute the web application, the sandbox process restricting the computing environment of the web application.

8. The method of claim 1, wherein the cached user interface state is stored in a distributed file system, and the method further comprises checking an integrity of the cached user interface state before the cached user interface state is communicated to the client device.

9. The method of claim 1, further comprising establishing a virtual network connection that restricts access of the web application to network resources based on a sandbox policy.

10. The method of claim 1, further comprising applying row-level security to the cached user interface state communicated to the client device.

11. A data platform comprising:
at least one processor; and
at least one memory storing instructions that cause the at least one processor to perform operations comprising:
receiving a request from a client device of a user to run a web application within a Computing environment;
initiating an execution of the web application;
determining an availability of a cached user interface state of the web application, the cached user interface state stored in a datastore;
in response to determining the cached user interface state is available, performing operations comprising:
fetching the cached user interface state from the datastore;
communicating the cached user interface state to the client device for displaying an initial user interface to a user by the client device using the cached user interface state; and
continuing to execute the web application while the initial user interface is displayed to the user.

12. The data platform of claim 11, wherein the operations further comprise:
polling the web application to determine an execution status of the web application; and
in response to the execution status indicating the web application is in a ready state, performing operations comprising:
receiving a results request from the client device for results from the web application, the results request in response to an interaction by the user with the initial user interface;
in response to receiving the results request, performing operations comprising:
generating the results using the results request;
communicating the results to the client device; and
updating the cached user interface state using the results.

13. The data platform of claim 11, wherein fetching the cached user interface state comprises querying a metadata database to retrieve specified data of the cached user interface state.

14. The data platform of claim 12, wherein updating the initial user interface using the results comprises modifying elements of the initial user interface that are displayed to the user without reloading the initial user interface.

15. The data platform of claim 11, wherein the operations further comprise validating communications between the client device and the web application during the execution of the web application using a user database role.

16. The data platform of claim 15, wherein the user database role determines a type of data included in the cached user interface state communicated to the client device.

17. The data platform of claim 11, wherein the operations further comprise employing a sandbox process to execute the web application, the sandbox process restricting the computing environment of the web application.

18. The data platform of claim 11, wherein the cached user interface state is stored in a distributed file system, and the operations further comprise checking an integrity of the cached user interface state before the cached user interface state is communicated to the client device.

19. The data platform of claim 11, wherein the operations further comprise establishing a virtual network connection that restricts access of the web application to network resources based on a sandbox policy.

20. The data platform of claim 11, wherein the operations further comprise applying row-level security to the cached user interface state communicated to the client device.

21. A computer-storage medium comprising instructions that, when executed by one or more processors of a machine, configure the machine to perform operations comprising:
receiving a request from a client device of a user to run a web application within a Computing environment;
initiating an execution of the web application;
determining an availability of a cached user interface state of the web application, the cached user interface state stored in a datastore;
in response to determining the cached user interface state is available, performing operations comprising:
fetching the cached user interface state from the datastore;
communicating the cached user interface state to the client device for displaying an initial user interface to a user by the client device using the cached user interface state; and
continuing to execute the web application while the initial user interface is displayed to the user.

22. The computer-storage medium of claim 21, wherein the operations further comprise:
polling the web application to determine an execution status of the web application; and
in response to the execution status indicating the web application is in a ready state, performing operations comprising:
receiving a results request from the client device for results from the web application, the results request in response to an interaction by the user with the initial user interface;
in response to receiving the results request, performing operations comprising:
generating the results using the results request;
communicating the results to the client device; and
updating the cached user interface state using the results.

23. The computer-storage medium of claim 21, wherein fetching the cached user interface state comprises querying a metadata database to retrieve specified data of the cached user interface state.

24. The computer-storage medium of claim 22, wherein updating the initial user interface using the results comprises modifying elements of the initial user interface that are displayed to the user without reloading the initial user interface.

25. The computer-storage medium of claim 21, wherein the operations further comprise validating communications between the client device and the web application during the execution of the web application using a user database role.

26. The computer-storage medium of claim 25, wherein the user database role determines a type of data included in the cached user interface state communicated to the client device.

27. The computer-storage medium of claim 21, wherein the operations further comprise employing a sandbox process to execute the web application, the sandbox process restricting the computing environment of the web application.

28. The computer-storage medium of claim 21, wherein the cached user interface state is stored in a distributed file system, and the operations further comprise checking an integrity of the cached user interface state before the cached user interface state is communicated to the client device.

29. The computer-storage medium of claim 21, wherein the operations further comprise establishing a virtual network connection that restricts access of the web application to network resources based on a sandbox policy.

30. The computer-storage medium of claim 21, wherein the operations further comprise applying row-level security to the cached user interface state communicated to the client device.
